(19) United States
(12) Patent Application Publication
(10) Pub. No.: US 2013/0011209 A1
(43) Pub. Date: Jan. 10, 2013

(54) Pipeline Conveyor Systems

(76) Inventor: Ian D. Doig, Dora Creek (AU)

(21) Appl. No.: 13/577,275

(22) PCT Filed: Jan. 19, 2011
(86) PCT No.: PCT/AU2011/000065

§ 371 Date: Sep. 10, 2012

(30) Foreign Application Priority Data
Feb. 7, 2010 (AU) 2010900480

(51) Int. Cl. B65G 53/66; B65G 53/58

(52) U.S. Cl. 406/15; 406/96

(57) ABSTRACT

A pipeline (500) equipped with at least one pump (400) transports granules dispersed in a carrier fluid in intervals between co-transported pigs in a pipeline. Each pump and each pig is configured to preserve the intervals between pigs, and the orientation of the pigs, during passage of the pigs and granules through each pump. Also, each pig may comprise peripheral apertures providing a leakage of carrier fluid into the intervals downstream of each pig as a means of preserving the dispersion of granules within the pipeline. In the example shown granules are introduced to the pipeline by inlet feed hopper (400), and granules are removed from the pipeline at outlet delivery hopper 650. Hopper 404 introduces pigs at the pipeline inlet and hopper 652 removes pigs at the pipeline outlet: pigs are returned to hopper (404) by the pipeline (500A).

This application claims the benefit of Australian Provisional Application No. 2010900480, filed 7 Feb. 2010, which is incorporated herein in its entirety.

### FIELD OF THE INVENTION

The present invention relates to hydraulic and pneumatic systems for the conveying of granules in pipelines, check valves, tubular diaphragm pumps, and pipeline “pigs”.

### BACKGROUND TO THE INVENTION

Conveying of granules in pipelines using a carrier fluid such as air or water is limited, inter alia, by the progressive separation and accumulation of larger-sized solids, particularly by in vertical rises and inclined sections of the pipeline. Progressive separation is limited where the void space between granules in the slurry is small (dense phase conveying), and where the density of the granules approaches the density of the carrier fluid. A particular example occurs in the pumped delivery of concrete slurries, but here the maximum size of aggregate is limited by the pump.

Pipeline Pigs are snug-fitting plugs of either a spherical, or a generally cylindrical geometry that travel through pipelines and are able to perform various tasks such as cleaning or removing deposits or blockages, and separating differing liquid batches from each other. A gaseous or liquid propellant is used to push the pig through the system and cylindrical pigs can be fitted with one or more deformable cups to assist their propulsion, or be a cylindrical plug of a deformable material. This strategy avoids loss of valuable product and reduces wash-out effluents. A problem occurs if the pigs pass through the pump, because the orientation of the pigs, and the separation of the fluids being conveyed, can be disturbed during passage through the pump. To avoid this problem, pigs are introduced into the pipeline upstream of each pump, and removed from the pipeline downstream of each pump.

Pigs are also used as capsules with internal cargo space for transporting dry goods by pipeline without using pumps, wherein individual capsules have induction-energised magnetic cores that are pulled sequentially through the pipe by a series of external-to-the-pipe linear motor coils. Capsules of the latter kind have been proposed for the pumping of liquids contained in the intervals between capsules. Examples can be found in “Industrial Pigging Technology” by G. Hiltscher, W. Mühlthaler and J. Smits; pub. Wiley GmbH, Germany 2006, and in U.S. Pat. Nos. 4,437,799 and 4,334,806. Means of introducing the capsules into the pipeline spaced at the required intervals are described, or exemplified, by U.S. Pat. No. 4,334,806. U.S. Pat. No. 4,437,799 calls attention to the absence of a prior efficient pump through which the capsules can pass and become propelled. Examples of linked capsules propelled through a pipeline by linear motors are provided in U.S. Pat. No. 4,234,271.

Pumps able to pass pigs without serious disturbance of material separated into the intervals between pigs are limited to peristaltic pumps, and tubular diaphragm pumps, but peristaltic pumps would excessively deform the pigs passing through each pump, thereby limiting their operating life. WO 2006/108219 provides the elements of a tubular diaphragm pump that can pass and propel capsules and the carrier fluid with the efficiency of a diaphragm pump, and introduce them into a pipeline.

It is noted that where batches of concrete slurries are hoisted by other than pipeline means, individual batch volumes are limited by aggregate segregation considerations.

### SUMMARY OF THE INVENTION

In first aspects the invention is a granules transport system comprising a pipeline having an inlet and an outlet and at least one pump disposed between the inlet and the outlet; a slurry disposed in the pipeline; the slurry comprising a carrier fluid and a plurality of granules dispersed in the carrier fluid; a plurality of pigs segregating the slurry into intervals; wherein the granules travel with the carrier fluid in the intervals from the inlet to the outlet; wherein the pump is configured to pump the slurry therethrough, with the pigs remaining present in the slurry, such that spacing between adjacent pigs is substantially maintained.

In second aspects the invention comprises aspects of the first aspect wherein the pump comprises a flexible tube having a passage therethrough that is subject to expansion and contraction during pumping; wherein the passage is sized and configured to allow passage of the pigs therethrough.

In third aspects the invention comprises aspects of the first aspect wherein the pump is further configured to maintain the orientation of pigs passing through the pump relative to the pipeline.

In fourth aspects the invention comprises aspects of the first aspect wherein the pump is a first pump, and further comprising a second pump disposed between the first pump and the outlet; wherein the second pump is configured to pump the slurry therethrough, with the pigs remaining present in the slurry, such that spacing between adjacent pigs is substantially maintained.

In fifth aspects the invention comprises aspects of the first aspect wherein the pump comprises a diaphragm pump comprising a pump inlet and a pump outlet; wherein at least one inlet check valve is attached coaxially to the pump inlet; wherein at least one outlet check valve is attached coaxially to the pump outlet; wherein each inlet check valve and each outlet check valve comprises a flexible tube having an inlet portion and an outlet portion; wherein each outlet portion is constrained against radially inward movement at three or more locations spaced around the periphery of the flexible tube. In sixth aspects the invention comprises aspects of the fifth aspect wherein the outlet portion of the flexible tube at least one of check valves comprises folds to facilitate changes in cross-sectional shape of the corresponding outlet portion as the corresponding check valve opens and closes.

In seventh aspects the invention comprises aspects of the sixth aspect wherein the outlet portion of the flexible tube having folds is biased to an unfolded configuration.

In eighth aspects the invention comprises aspects of the sixth aspect and also comprises at least one stiff ring surrounding the outlet portion of the flexible tube of at least one of the check valves; wherein that outlet portion is anchored to the stiff ring at three or more locations corresponding to the three or more locations where the outlet portion is constrained against radially inward movement.

In ninth aspects the invention comprises aspects of the first aspect and also comprises a feed station disposed between the inlet and the pump; wherein the feed station is operative to feed pigs into the pipeline upstream of the pump.

In tenth aspects the invention comprises aspects of the sixth aspect and also comprises a delivery station disposed proximate the outlet; the delivery station operative to separate the pigs from the slurry; a pig return line operatively connecting the delivery station to the feed station such that pigs from the delivery station are recycled to the feed station.

In eleventh aspects the invention comprises aspects of the tenth aspect wherein the pig return line contains carrier fluid to be recycled; wherein the pig return line is sized to be bigger than the pigs such that at least some of the carrier fluid therein may move past the pigs therein.

In twelfth aspects the invention comprises aspects of the first aspect wherein the pump comprises a check valve having a flexible tube; the flexible tube having an upstream portion and a downstream portion; wherein the upstream portion is configured to substantially close when pressure at an outlet of the pump is higher than a pressure at an inlet of the pump;

wherein the upstream portion is configured to open when the pressure at the inlet of the pump is higher than the pressure at the outlet of the pump; wherein the downstream portion is restrained from closing when the pressure at the inlet of the pump is higher than the pressure at the outlet of the pump.

In thirteenth aspects the invention comprises aspects of the first aspect wherein the pigs comprise at least two spaced apart flexible rims mounted to a shaft; wherein each of the flexible rims is resilient and comprises a plurality of peripheral apertures.

In fourteenth aspects the invention comprises aspects of the ninth aspect wherein the pigs are buoyant in the carrier fluid.

In fifteenth aspects the invention comprises aspects of the first aspect wherein each pump in the pipeline comprises a first detector sensing the pressure upstream of each pump and a second detector sensing the pressure downstream of each pump; whereby, when the pressure upstream falls to a first pre-determined level, the first detector triggers the pump to cease pumping; whereby, when the pressure upstream rises to a second pre-determined level, the first detector triggers the pump to begin pumping; whereby, when the pressure downstream falls to a third pre-determined level, the second detector triggers the pump to begin pumping; whereby, when the pressure downstream rises to a fourth pre-determined level, the second detector triggers the pump to cease pumping; wherein the first, second, third and fourth pre-determined levels differ for each pump.

### BRIEF DESCRIPTION OF THE DRAWINGS

Preferred embodiments of the invention will now be described, by way of examples only, with reference to the accompanying drawings in which:

FIG. 1 is a side view of a flexible tube check valve in half cross section.

FIG. 2 is an end view in cross section of the flexible tube check valve and reinforcing members of FIG. 1 in the closed position viewed in the direction of the arrows X-X.

FIG. 3 is an end view in cross section of the flexible tube check valve and reinforcing members of FIG. 1 in the fully open position viewed in the direction of the arrows X-X.

FIG. 4 is a side view in cross section of a tubular diaphragm pump with an electro-magnet-driven motor.

FIG. 5 is an end view in cross section of the flexible tube and retaining cage of FIG. 1 in the fully open position viewed in the direction of the arrows Y-Y, and FIG. 5 is also an end view in cross section of the flexible tube and retaining cage of FIG. 2 in the fully open position viewed in the direction of the arrows Z-Z.

FIG. 6 is an end view in cross section of the flexible tube and retaining cage of FIG. 1 in the closed position viewed in the direction of the arrows Y-Y, and FIG. 6 is also an end view in cross section of the flexible tube and retaining cage of FIG. 2 in the closed/open position viewed in the direction of the arrows Z-Z.

FIG. 7 is an end view in cross section of the flexible tube and retaining cage of FIG. 1, with a restoring means, with the valve closed, seen in the direction of the arrows Y-Y, and FIG. 7 is also an end view in cross section of the flexible tube and cage of FIG. 2 viewed in the direction of arrows Z-Z.

FIG. 8 is a schematic showing check valves of FIG. 1 assembled with a tubular diaphragm pump element of FIG. 4 to form a tubular diaphragm pump.

FIG. 9 is a schematic showing a side view of a feed hopper in cross section delivering pigs and granules and carrier fluid at intervals into a pipeline entry.

FIG. 10 is an end view of the FIG. 9 feed hopper viewed in cross section on arrows W-W.

FIG. 11 is a schematic showing an enlargement of the detail A in FIG. 9.

FIG. 12 is an end view of the FIG. 9 feed hopper viewed in cross section on arrows V-V.

FIG. 13 is a schematic showing a plan view of a delivery hopper receiving pigs, granules and carrier fluid exiting a pipeline.

FIG. 14 is a schematic showing an arrangement of a looped pipeline with granules and carrier fluid feed and delivery stations where the granules and carrier fluid is conveyed in the intervals between pigs in the pipeline.

FIG. 15 is a schematic showing the feed hopper of FIG. 9 in a closed configuration, and fitted with rotating vane valves for the entering granules and the pigs.

FIG. 16 is a schematic end view in cross section of the feed hopper of FIG. 15 viewed on arrows W-W.

FIG. 17 is a schematic showing an alternative arrangement of the looped pipeline of FIG. 14.

FIG. 18 is a schematic showing an alternative arrangement for feeding pigs to that shown in FIG. 9.

FIG. 19 is a schematic showing an alternative arrangement for feeding pigs to that shown in FIG. 18 where the pigs are linked at intervals by cables.

FIG. 20 is an end view in cross section of a preferred pig.

### DETAILED DESCRIPTION OF PREFERRED EMBODIMENTS

Preferred embodiments of the invention and their alternatives will now be described, by way of examples only, with reference to the accompanying drawings in which:

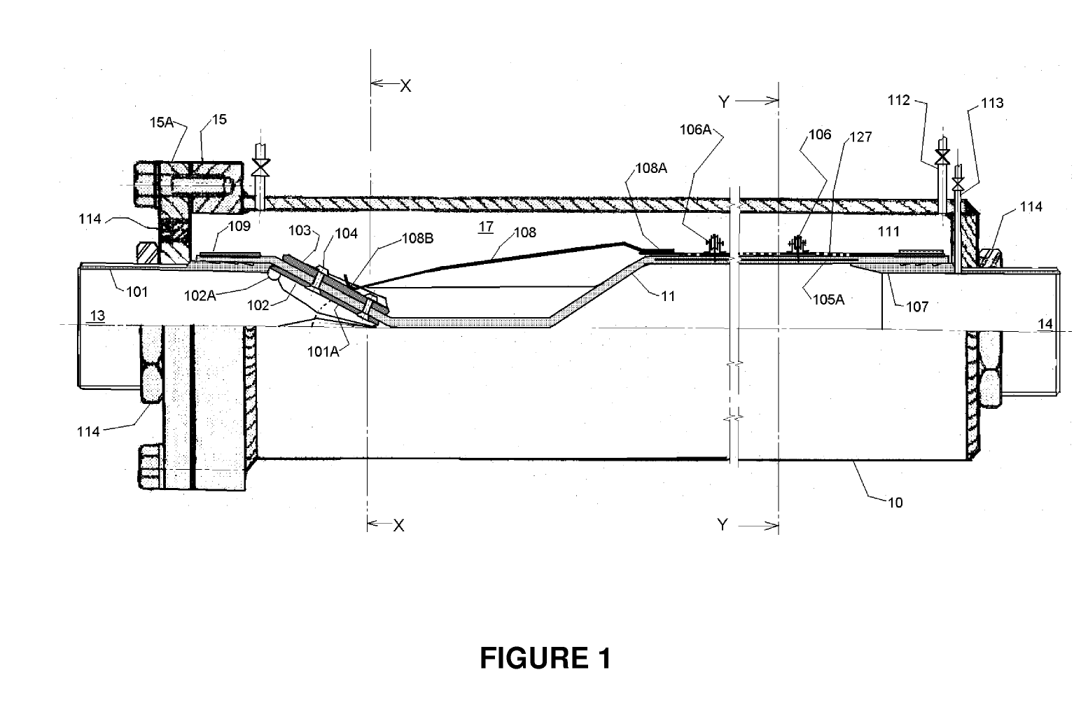

FIG. 1 shows a side view in cross section of a check valve in its closed position with a flexible tube serving as the valve. It is an example of the fourth aspect of the invention.

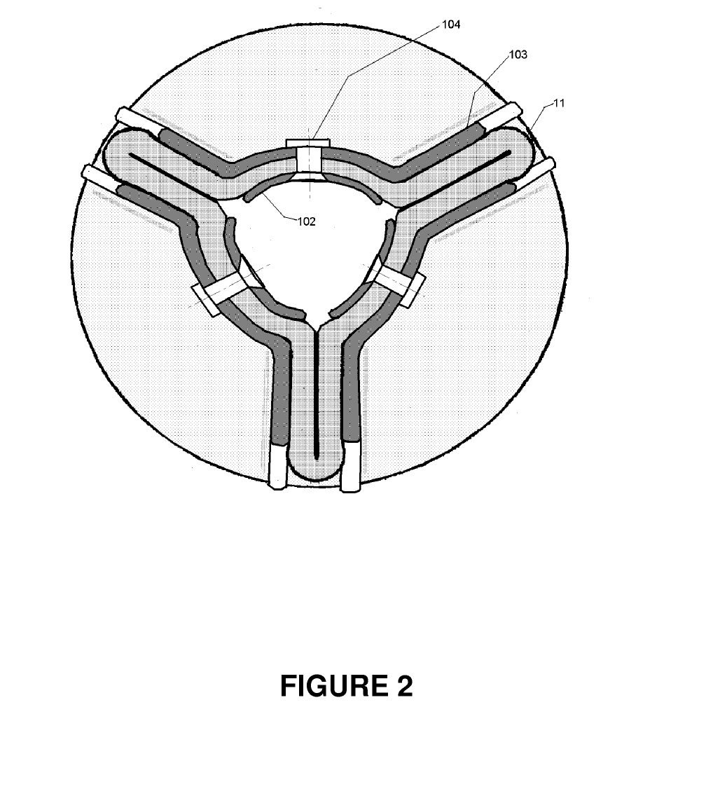

FIGS. 2, 3, 5, 6 and 7 show selected cross section end views of the check valve.

To assist description the flexible tube is described as having five regions. Region 1 begins at the inlet and encloses a spigot 101 providing support at the valve inlet. Region 2 transitions from the open shape at the inlet to the closed shape of region 3. Region 4 transitions from the closed shape of region 3, to the open shape of region 5, wherein region 5 is adjacent the outlet.

When the valve is closed the flexible tube in region 1 is partly supported against external pressure by the spigot 101, and the pressure difference between the valve outlet and inlet is carried by the flexible tube in regions 2 and 3. In region 3 inner surfaces of the flexible tube meet and support each other, but region 2 contains parts that are prone to inwards collapse when the valve outlet pressure is high.

The flexible tube 11 is typically formed from synthetic rubber and reinforced with a strong, but flexible, embedded woven fabric. The flexible tube 11 is sealingly clamped at its inlet and outlet ends around the spigots 101 and 107 by clamping straps 109 and 111.

The spigot 107 (at the valve outlet end) has a conical inlet, but the outlet end of spigot 101 is cut as shown to provide flat surfaces 101A that add support to (reinforce) the flexible tube in region 2 against externally applied pressure when the valve is closed. Additional support (reinforcement) is provided by stiff members 102, which are attached to the inner wall of the flexible tube by rivets or bolts 104 and outer stiff plates 103. Stiff members 102 have protrusions that pivot about grooves 102A at the inlet end of each flat surface 101A. Although only two rivets or bolts 104 are shown (fastening the stiff members 102 and stiff plates 103 together) a larger number may be needed.

Excursions of the flexible tube 11, in regions adjacent the valve outlet, towards local closings when the valve opens is limited by the stiff retaining tube 127, which is perforated. Flange 15, bolted cover plate 15A and the securing nuts 113 allow the flexible tube to be sealingly encased within valve body 12, and permit easy dismantling for flexible tube replacements. A sealed screwed plug 114 allows access to the enclosed space 17 for adjusting the liquid inventory.

When the valve 100 is closed, fluid is prevented from passing from its outlet to its inlet, and when it is fully open, carrier fluid, granules, and a deformable pig can pass from its inlet to its outlet.

When the valve is operating the enclosed space 17 is normally sealed and filled with a non-volatile, substantially incompressible, fluid.

In FIG. 1 flexible tube 11 is shown closed over its upstream regions, and open over downstream regions, which is its normal, or relaxed, state. The downstream regions are sufficiently long (a longer-than-shown length indicated by the split-view lines) to remain substantially open when the upstream region of the valve is closed. When the pressure at the valve outlet 14 is larger than the pressure at the inlet 13, the flexible tube walls adjacent the outlet inflate, displacing fluid in space 17 towards the inlet, squeezing the inlet region flexible tube walls together into a three lobes shape (when viewed from the valve outlet) to close the valve as shown.

When the valve inlet pressure is larger than that at the outlet, the flexible tube walls adjacent the inlet move outwards, displacing fluid in the enclosed space 17 towards the outlet, but the flexible tube walls there are restrained from closing together, and the valve opens.

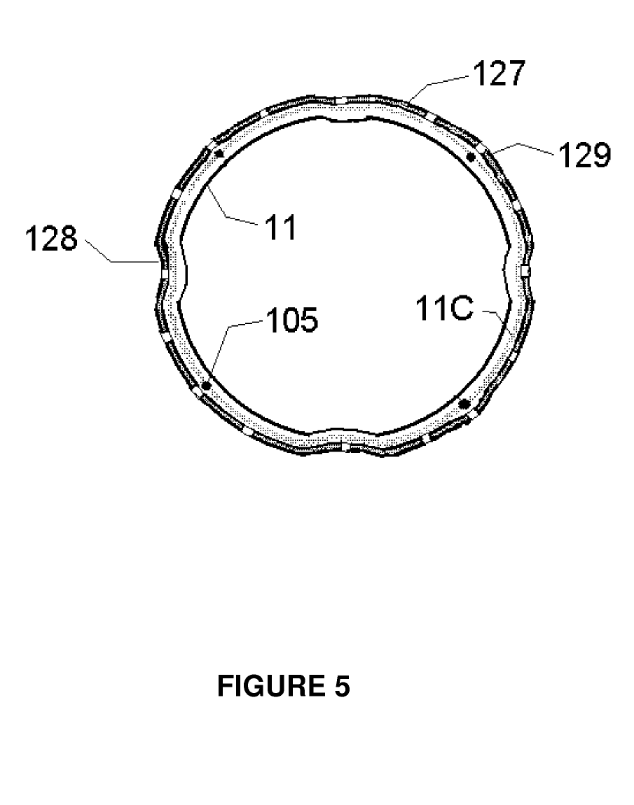

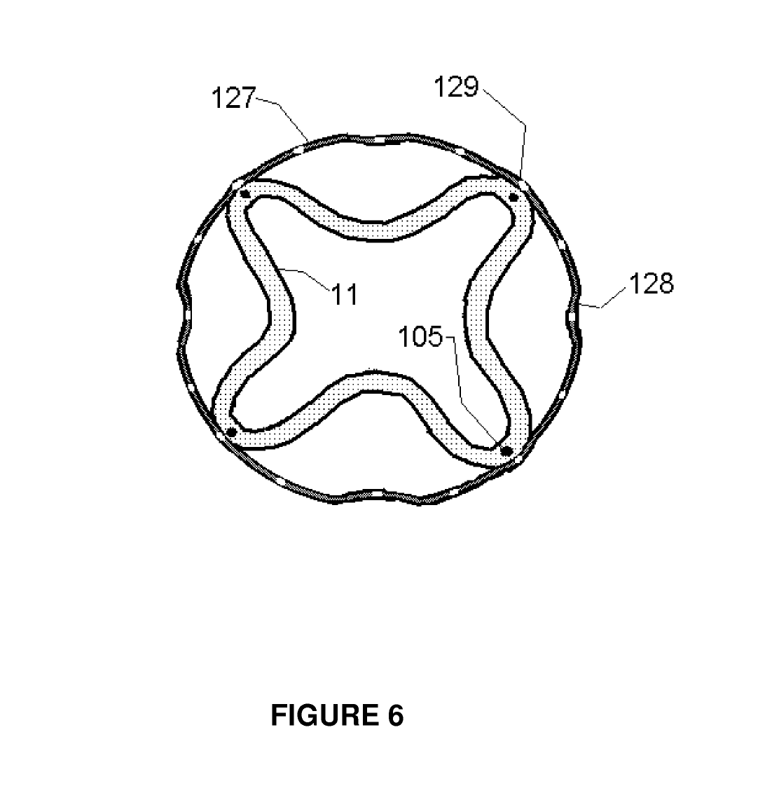

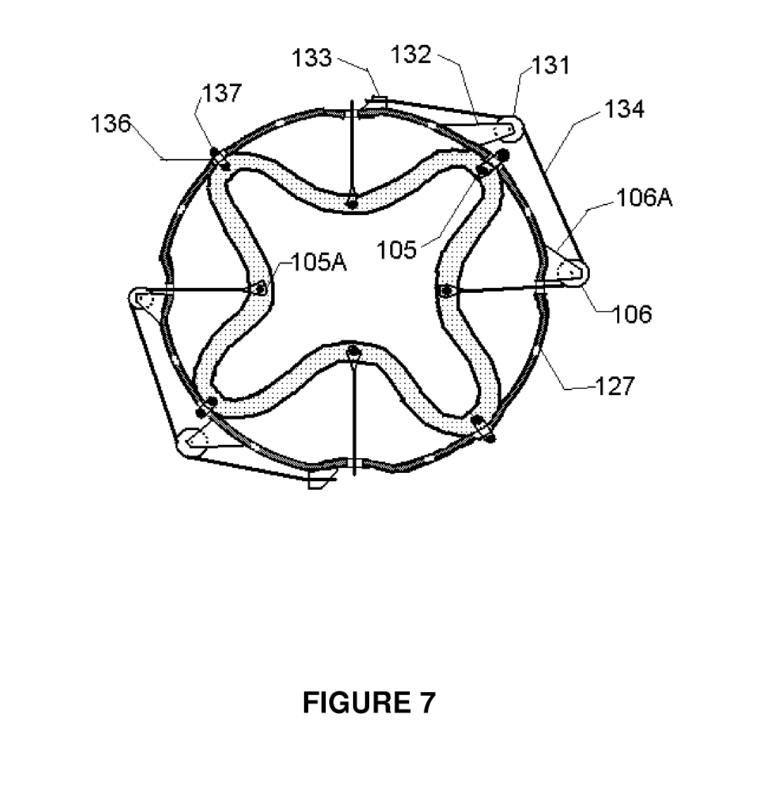

A stiff tubular restraining cage 127 surrounds the flexible tube 11 adjacent the valve outlet to limit any local outwards excursions of the flexible tube. A leaf spring 108 extends from the retaining cage 127 at anchor location 108A to assist the stiffening member 103 to close the valve: stiff or resilient rods 105 embedded in the flexible tube 11 inhibit local incursions of the flexible tube. In FIGS. 5 and 6 a reinforcement fabric 110 is embedded in the wall of the flexible tube 11, and the flexile tube is attached at spot locations 129 to the retaining cage 127 by either an adhesion means, or a fusion means, or a tethering means. Small intrusions 128 of the otherwise circular shape of the retaining cage transmit those intrusions to the flexible tube adjacent the valve outlet when the valve is closed (when the flexible tube is fully expanded within the retaining cage): these intrusions in the flexible tube initiate inwards movement of the flexible tube towards the flexible tube shape shown in FIG. 6 when the valve is open. An example of an alternative tethering means is shown by the links 136 that link the embedded stiff or resilient rods 105 to the pins 137 outside of the retaining tube 127 in FIG. 7. Thus a valve is provided which opens and closes automatically according to the difference in pressure at the valve inlet, and at the valve outlet. Small tubes with valves 110, 112 and 113 are provided to allow fluid to be inserted, or to be withdrawn, from the enclosed space 17 during a servicing of the valve. These valves 110, 112 and 113 are fully closed in normal use, to prevent ingress or egress of the fluid from the enclosed space 17.

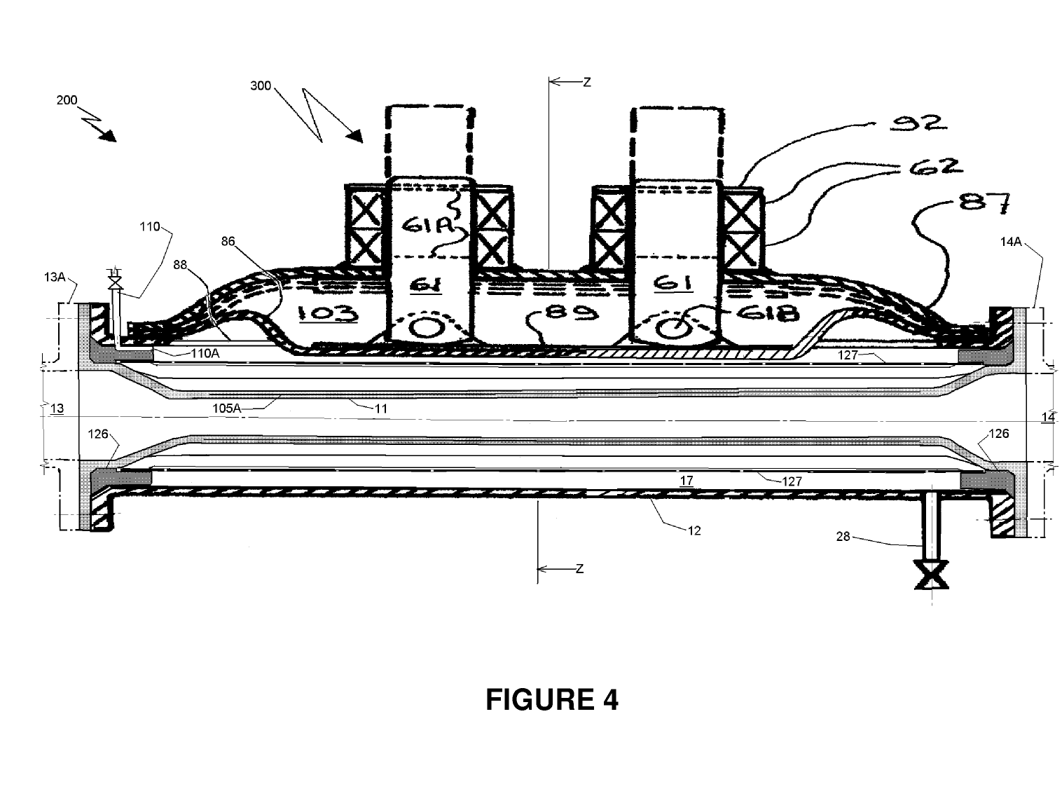

However, the flexible tube 11 may be punctured during operations, which could lead to a progressive and deleterious increase or decrease of the enclosed space 17 inventory. Alternatively, the flexible tube 11 of the tubular diaphragm pump of FIG. 4 has no means of restoring the flexible tube 11 to its fully open position other than the withdrawal of motive fluid from the motive fluid space 17. To counter this, the flexible tube shown in FIG. 1 is biased by its construction to be closed in its inlet regions and open in its outlet regions.

In FIG. 7, further bias towards opening of the flexible tube 11 in regions outlet adjacent the outlet of the valve in FIG. 1 (or of the flexible tube 11 in FIG. 4) is provided by the system of embedded resilient rods 105A, stretched elastic cables (or tension springs) 134 looped around resilient rods 105A, pulleys 106 and 131, and pulley spindle mountings 106A and 132. Stretched elastic cables (or tension springs) 134 are anchored to the wall of retaining tube 127 by anchors 133. Additional pulleys 106 and 131, and pulley spindle mountings 106A and 132, disposed further around the retaining tube 127, with the anchors 133 appropriately re-located to provide for longer stretched elastic cables (or tension springs) 134, may be provided. A plurality of embedded resilient rods, stretched elastic cables, pulleys, pulley spindle mountings and anchors operate to resist inward propulsions of the flexible tube.

Whenever the FIG. 1 valve is in its closed configuration for a sufficient period any changes in the inventory (though tube porosity or puncturing) of the enclosed volume 17, become remedied by the plurality of embedded resilient rods, stretched elastic cables, pulleys, pulley spindle mountings and anchors.

In further uses of the flexible tube an air-release-valve and check-valve in series can be fitted to the most elevated tubes with valves 110 and 112 to vent any compressible gases that may enter the enclosed volume, and an appropriate enclosed filter can be connected between the tubes with valves 113 and 112 to allow gradual adjustments of the enclosed volume inventory towards normal during valve operations.

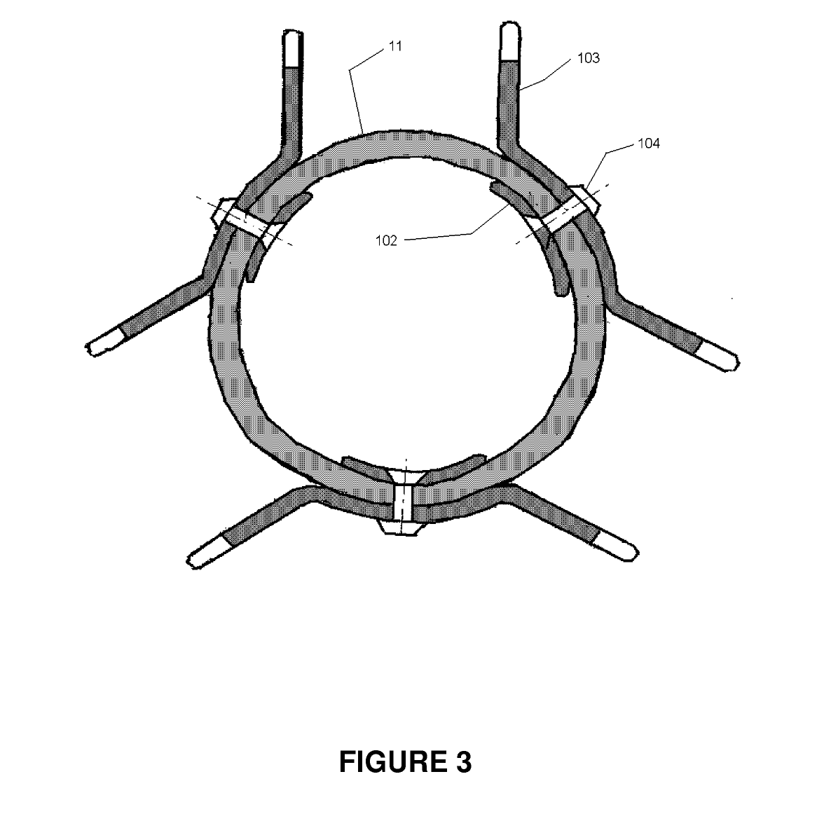

FIGS. 2 and 3 show two different end views in cross section of the check valve 100 of FIG. 1 in the direction of the arrows X-X in the region 2. Like numerals indicate features in common with FIG. 1. FIG. 2 shows the flexible tube inwardly closed and forming three lobes. FIG. 3 shows the flexible tube open. Although a valve forming three lobes is shown, the arrangement can be extended to valves forming more than three lobes (e.g. FIGS. 6 and 7).

FIGS. 5, 6 and 7 show end views in cross section of the check valve 100 of FIG. 1 in the direction of the arrows Y-Y in the region 5. Alternatively, FIGS. 5, 6 and 7 show end views in cross section of the flexible tube 11 and retaining tube 127 of the tubular diaphragm pump element 200 of FIG. 4 in the direction of the arrows Z—Z. Like numerals indicate features in common with FIGS. 1, 2, 3 and 4.

FIG. 6 shows the flexible tube in the fifth region of FIG. 1 (or the corresponding third region of FIG. 4) when the valve is open. FIG. 5 shows the flexible tube in the fifth region of FIG. 1 (or the corresponding third region of FIG. 4) when the valve is closed. Note that there are four inwardly folding lobes, and the flexible tube remains open.

FIG. 7 shows an alternative arrangement of the flexible tube of FIG. 6 with the system of embedded resilient rods 105A, stretched elastic cables (or tension springs) 134, resilient rods 105A, pulleys 106 and 131, pulley spindle mountings 106A and 132, and anchors 133, which serve to restore the flexible tube 11 towards its most open shape when the valve closes.

FIG. 4 is a side view in cross section of an adaption of the flexible tube to serve as a tubular diaphragm pump element 200 that provides an example of a motorised pumping means. Numbers that are common to FIGS. 1, 2, 3, 5, 6 and 7 indicate components that have basically the same function, and obtain substantially the same description provided above for those figures. In FIG. 4 a drive unit 300 of a motorised pumping means is directly attached to the valve body 12 of a pinch valve, and a motive fluid space 17 is filled with gas-free hydraulic liquid.

The electro-magnetic drive unit mechanism 300 moves a diaphragm 86 that is sealingly clamped around its edges, between a flat-surfaced flange 88 that extends from the valve body 12 around the periphery of the diaphragm 86, and a stiff cover 87. The diaphragm 86 is also clamped between stiff plates 89 on the inside and the outside of the diaphragm 86 over its central regions. The diaphragm 86 and the flange 88, and mating parts are circular, elliptical, obround, or rectangular when viewed from above in plan.

Electro-magnetically actuated solenoids 61, attached by hinges 61 B to stiff plate 89 move diaphragm 86 towards the valve axis to close the valve, and away from the valve axis to open the valve. Appropriate energising of the electro-magnet coils 62 moves both solenoids in reciprocating pump delivery and suction strokes of this adaption of a pinch valve.

Each solenoid has a vertical slot 61A that allows the solenoid to slide about a guide pin 92 that limits the vertical movement of the solenoid between the valve open and closed positions. Coils 62, and pins 92 are securely attached to the cover 87 and space 103 is air filled and vented.

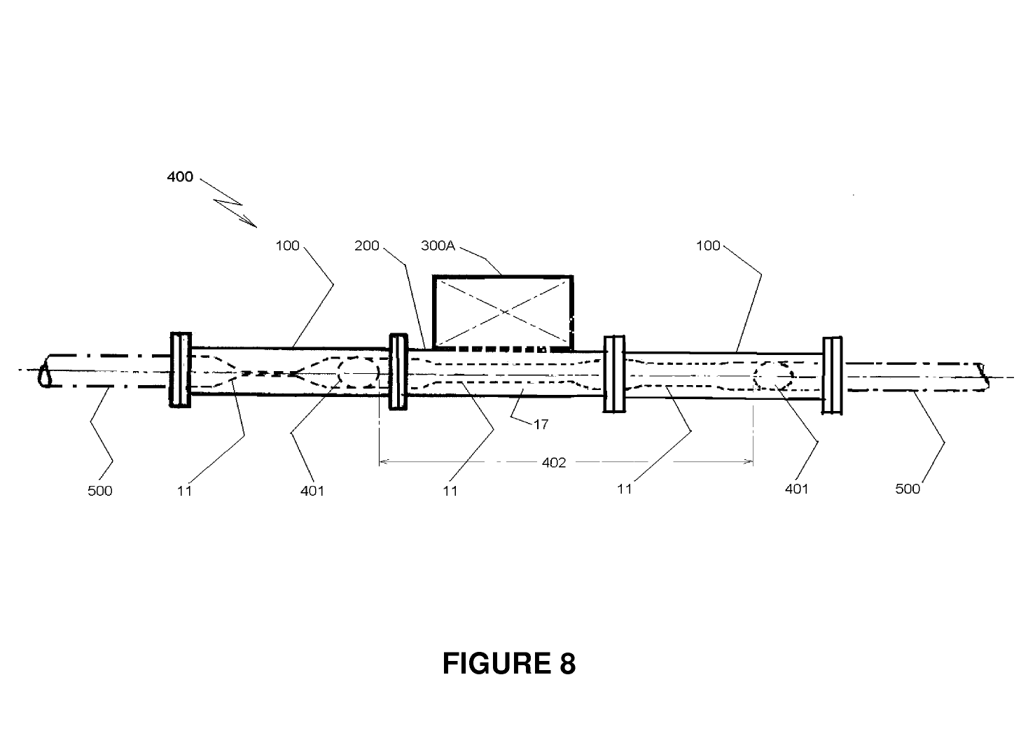

In an alternative arrangement the above electro-magnetic drive unit mechanism 300 and diaphragm 86 may be replaced by an external reciprocating sealed and sliding plunger (or piston) enclosed in a cylinder of the prior art with its cylinder volume sealingly communicating with the motive fluid space 17 through a common port, so that variations of the cylinder volume caused by the reciprocating plunger (or piston) displace the flexible tube 11 to provide the delivery and suction stroke of this pumping unit. A pumping unit of this description is shown schematically in FIG. 8.

The stiff retaining tube 127 is securely held in place by the spigots 126 at the valve region 1 inlet end, and at the region 5 outlet end. Note that the stiff retaining tube 127 also provides support for the flexible tube against internal pressure in its most open state in the event that the diaphragm fails. Note that, because the flexible tube is never closed, it does not need the reinforcement members of FIG. 1: containment of pressure at the pumping unit 200 outlet is provided by the inlet and outlet check valves shown in FIG. 8.

FIG. 8 is a schematic example showing a tubular diaphragm pump 400, comprising a tubular diaphragm pump 200, with a check valve 100 at its inlet and a check valve 100 at its outlet, securely and sealingly assembled into a serial end-to-end and in-line arrangement, and sealingly and securely inserted into a pipeline 500, in which the flexible tube 11 of the check valves 100 (exemplified in more than one form by FIGS. 1, 2, 3, 5 and 6, or 7) is a common element. In a more general example the pumping unit 400 of FIG. 8 may have one or more check valves 100 in a serial end-to-end arrangement at its inlet and outlet ends to provide a better higher delivery pressure capacity.

The drive unit mechanism 300A may be the electro-magnetic drive unit mechanism 300 driving a diaphragm of FIG. 4, or it may be a reciprocating plunger, or piston, sliding sealingly within a cylinder, and displacing fluid within the motive fluid space 17 of the pumping unit 200 to produce the required pumping action, or it may be a mechanised valves means of delivering motive fluid at regular intervals to the motive fluid space 17, and allowing the pressure within the flexible tube, or the plurality of embedded resilient rods, stretched elastic cables, pulleys, pulley spindle mountings and anchors of FIG. 7 to re-inflate to expel motive fluid from the motive fluid space 17 between said regular intervals.

FIG. 8 also shows a typical example of pigs 401 separated at intervals 402 wherein the pumped granules and carrier fluid are transported. The pigs 401 may be spherical or substantially cylindrical in geometry, or of a geometry comprising two or more saucer-shaped discs; wherein all pigs have deformable but resilient rim parts that enable the pig to slide sealingly through the pump 400 and its valves 100; wherein each pig has an inner core constructed so that the density of each pig 401 is more dense, or less dense, than the conveyed slurry, according to needs. Note that small leakages of the carrier fluid past the pigs at its sliding edges can assist by lubricating the sliding, and that pigs may contain apertures disposed around the rim parts to allow a limited leakage of carrier fluid past the pig in the pipeline to assist the dispersion of granules in the carrier fluid.

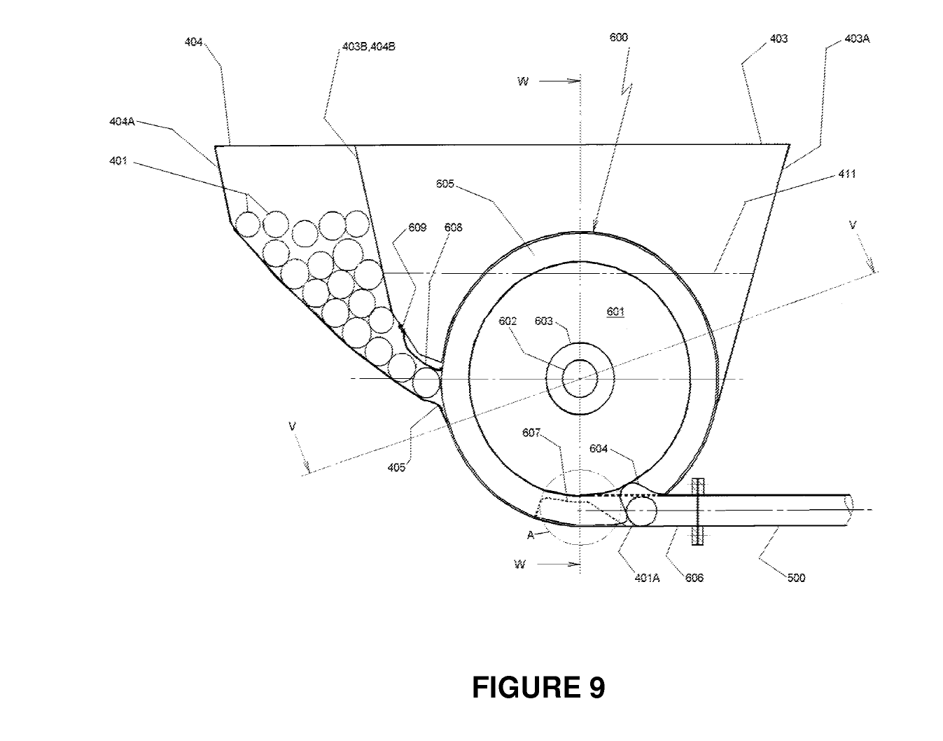

FIG. 9 is a schematic showing an example of a feed station serving the pipeline 500 of FIG. 8, wherein the pigs 401 are spherical, deformable but resilient, and of a size larger than the pipeline bore (to provide a sliding seal), and are more dense than the carrier fluid.

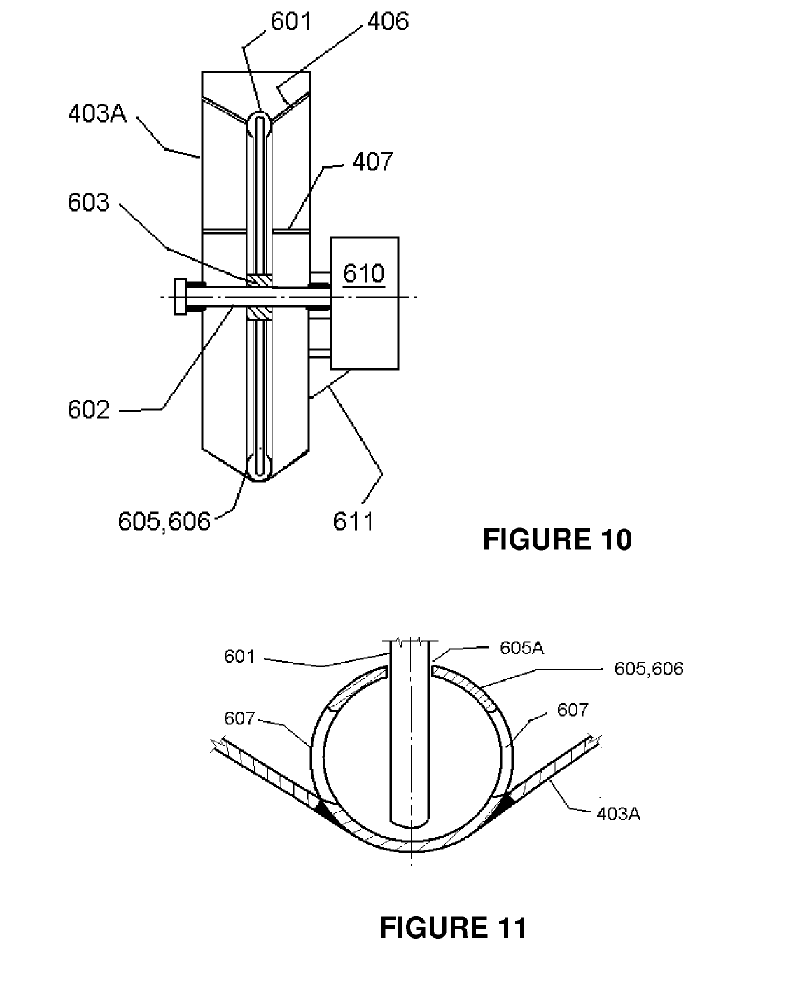

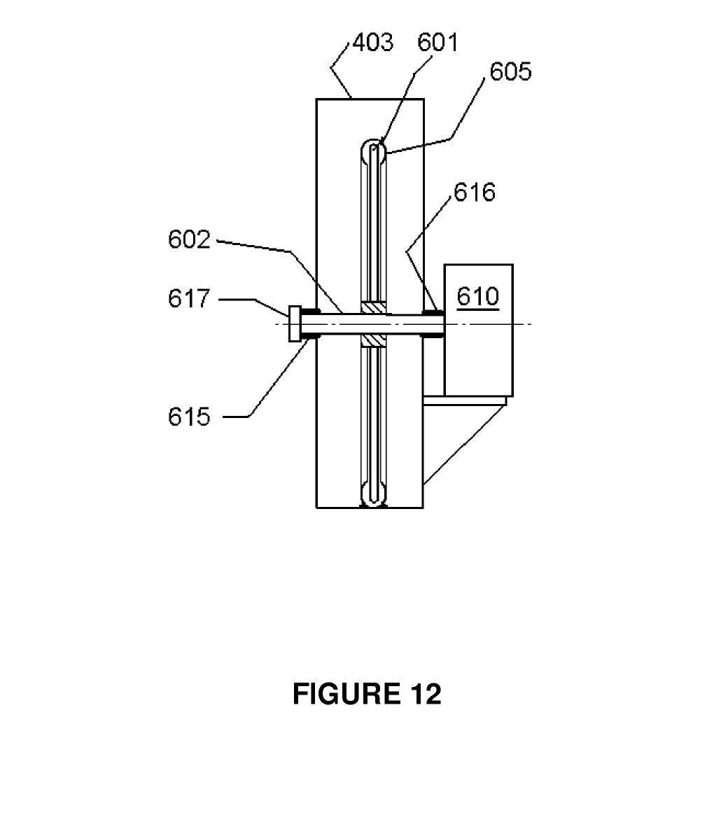

FIGS. 10 and 12 show end views on the arrows W-W, and on the arrows V-V, in FIG. 9.

FIG. 11 shows an enlargement in cross-section of the detail A in FIG. 9. Like numerals indicate features common to FIGS. 9, 10 and 11.

The feed station comprises a slurry (granules plus carrier fluid) hopper 403, a recycled pigs reservoir 404, and a rotating disc gating mechanism 600 with external-to-the-hopper drive unit 601, whereby the pigs are controllably fed at the required intervals into the pipeline 500 at entry 606.

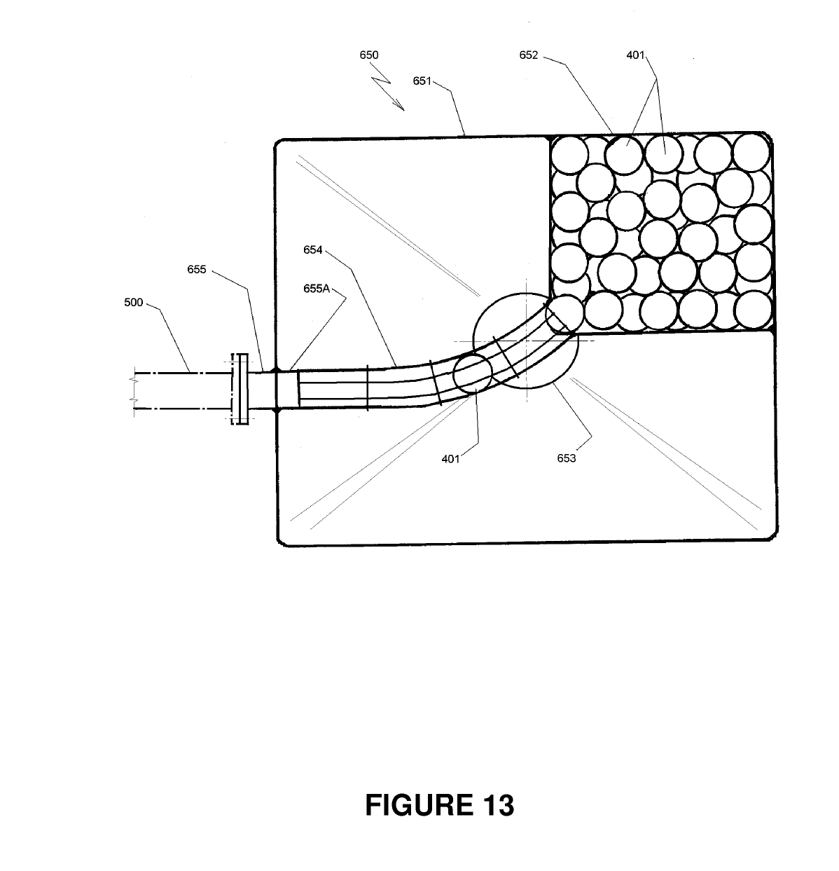

The granules and carrier fluid are held in the slurry hopper 403 where the level should preferably not rise above the level 411. The slurry hopper has walls 403a and 403B. Pigs 401, returned from the delivery hopper 650 of FIG. 13, are held in the pigs hopper 404, which has walls 404A and 404B.

The rotating disc gating mechanism 600 comprises the rotating disc 601, an annular pipe 605 (slit around its inside to accommodate the rotating disc 601), openings 607 in the tube 605 wall (to permit granules and carrier fluid to enter the entry 606), and the rotating disc 601 has a notched recess 604 (to receive a single pig 401 and deliver it past the opening 607 and into entry 606), and it rotates in an anti-clockwise direction (the direction of flow in the pipeline) as seen in FIG. 9.

The hopper drive unit 601 rotates the disc 601 through the shaft 602 and disc boss 603 so that individual pigs are accepted from pigs hopper 404 at entry point 405 as the recess 604 first passes; then delivers them to entry 606 after passing the openings 607. After a pig passes the opening 607 granules and carrier fluid are drawn into the openings 607 and into entry 606 until the next pig arrives. The drive unit mechanism has a pawl/ratchet spring mechanism 608 that allows the disc 601 to rotate freely forwards and allow the pig to be swept into the entry as it passes the openings 607: the mechanism also exerts a weak dragging action on the pig until it is swept into the entry. The rotation speed of the drive unit 610, and the average granules and carrier fluid velocity in the pipeline 500 determines the interval 402 of FIG. 8. To avoid wear of pigs (by the rotating disc 601) waiting to be accepted a pawl/ratchet spring 608, anchored to hopper wall at anchor 609, and held down by the rim of the disc 601, holds each pig, until the arrival of recess 604 allows the pawl/ratchet spring to rise and release a pig into the recess. In FIG. 10, the annular pipe 605 is anchored to the hopper walls by stay bars 406 and 407. In FIG. 12, shaft 602 runs in journals 616 and 617. In alternative examples the disc may have two, or more, recesses 604, spaced at intervals around its rim to allow shorter intervals 402 (see FIG. 8), wherein the intervals are determined by the relationship between the mean granules and carrier fluid velocity in the pipeline and the rotation speed of the disc 601.

FIG. 13 is a schematic showing an example of a plan view of a slurry delivery station 650 serving the pipeline 500 of FIG. 8, wherein the pigs 401 and granules and carrier fluid exit the pipeline at nozzle 655A, and pass through a curved and descending (to assist separation) rail-lined conduit, or slotted pipe, 654 to a delivered pigs hopper 652, while the granules and carrier fluid fall through the curved rails, or pipe slots, into a slurry receiving hopper 651. Granules and carrier fluid exit the hopper 651 through the central base outlet port 653.

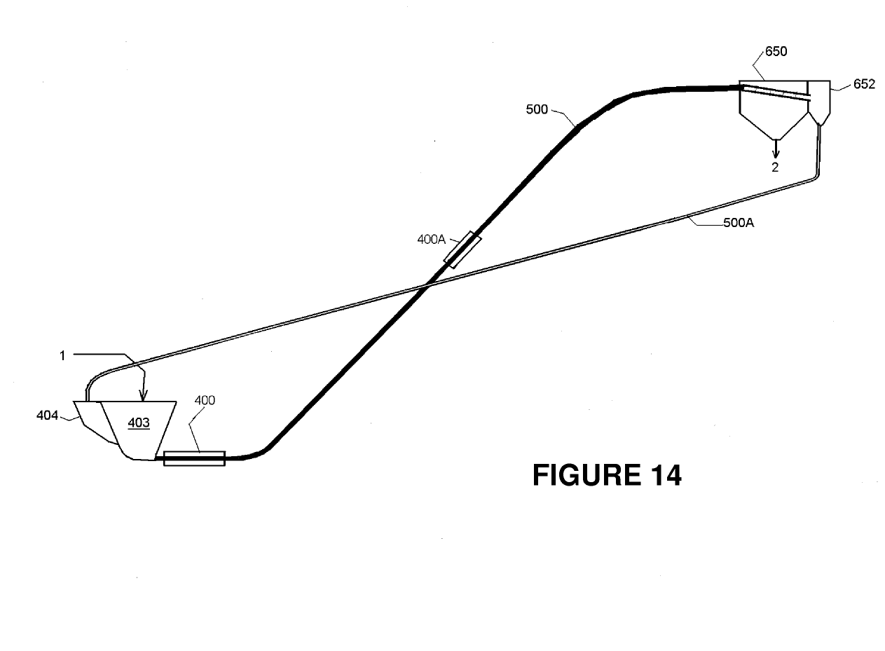

FIG. 14 is a schematic showing more than one pump 400 of FIG. 8, positioned in the pipeline 500 operating to transport granules dispersed in a carrier fluid within intervals (402 of FIG. 8) between co-transported pigs from a feed hopper 403 to a delivery hopper 650, with pigs recycled through conduit 500A between the reservoirs 404 and 652 at the feed and delivery stations. Tubular diaphragm pump 400A exemplifies at least one intermediate boosting tubular diaphragm pump in the pipeline 500. Note that the propulsion impulses provided by each pump to the transported materials (granules, carrier fluid, and pigs) need to complement those of the other pumps.

A means of achieving this is to introduce detectors sensing the pressure upstream of the inlet, and downstream of the outlet, of each pump: when the pressure upstream of the inlet falls to a first pre-determined level the detector triggers the pump to begin pumping: when the pressure upstream of the inlet rises to a second pre-determined level the detector triggers the pump to cease pumping: when the pressure downstream of the outlet falls to a third pre-determined level the detector triggers the pump to begin pumping: when the pressure downstream of the outlet rises to a fourth pre-determined level the detector triggers the pump to cease pumping.

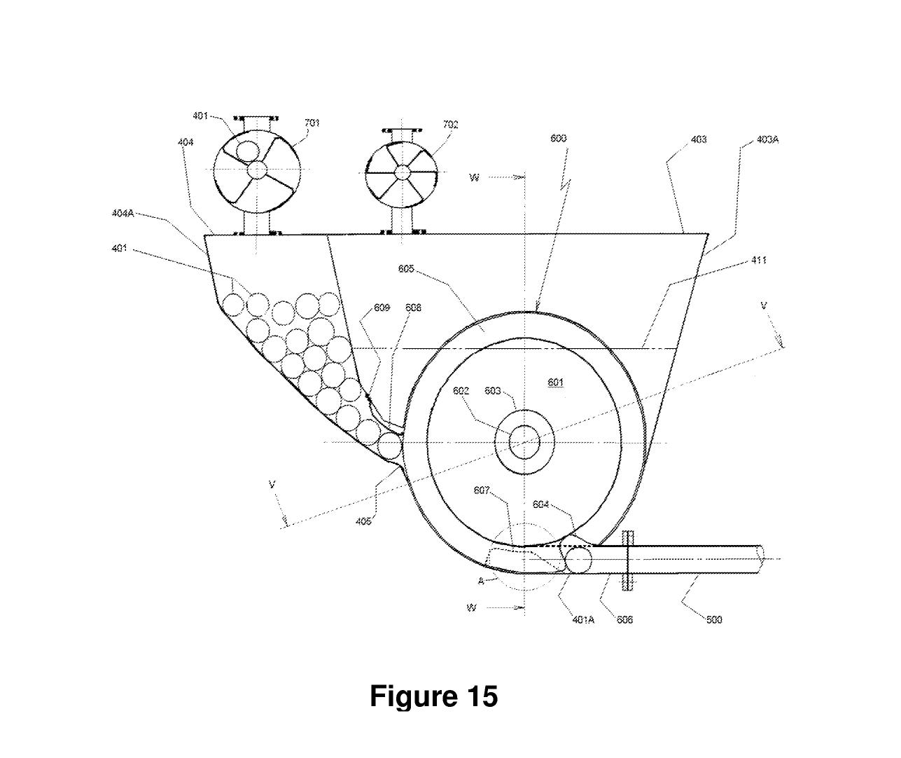

FIG. 15 is a schematic showing an example of an alternative feed station to that shown in FIG. 9, which is suited to the use of a pressurised carrier fluid injected into the granules hopper 403; wherein the granules hopper 403 and the recycled pigs reservoir 404 form a closed vessel; wherein granules are fed through the rotating vanes valve 702 into the hopper 403; wherein recycled pigs 401 are fed through the rotating vanes valve 701 into the reservoir 404. The pressurised carrier fluid may be compressed air or pumped water. Elsewhere like numbers and letters indicate items that obtain the same description as for prior figures. In alternatives pressure-zone separating, appropriately-valved, lock hoppers can replace the rotating vanes valves.

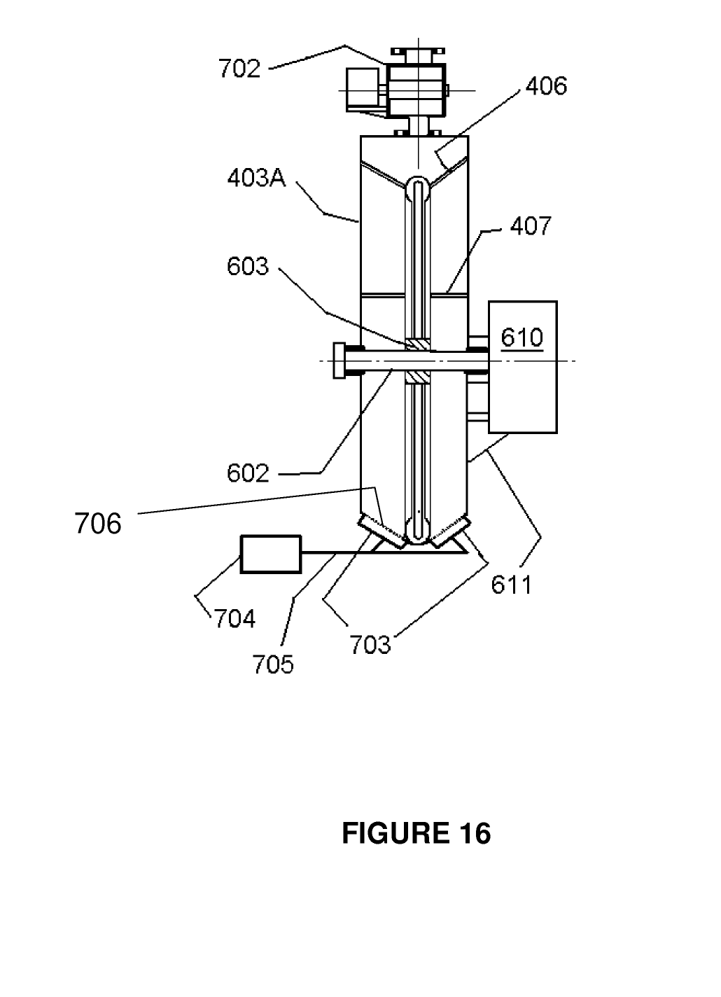

FIG. 16 is an end view in cross section on the arrows W-W of FIG. 15 showing pressurised carrier fluid injection boxes 703, with inlet diffuser pads 706, the pressurised carrier fluid source 704, and conduit 705.

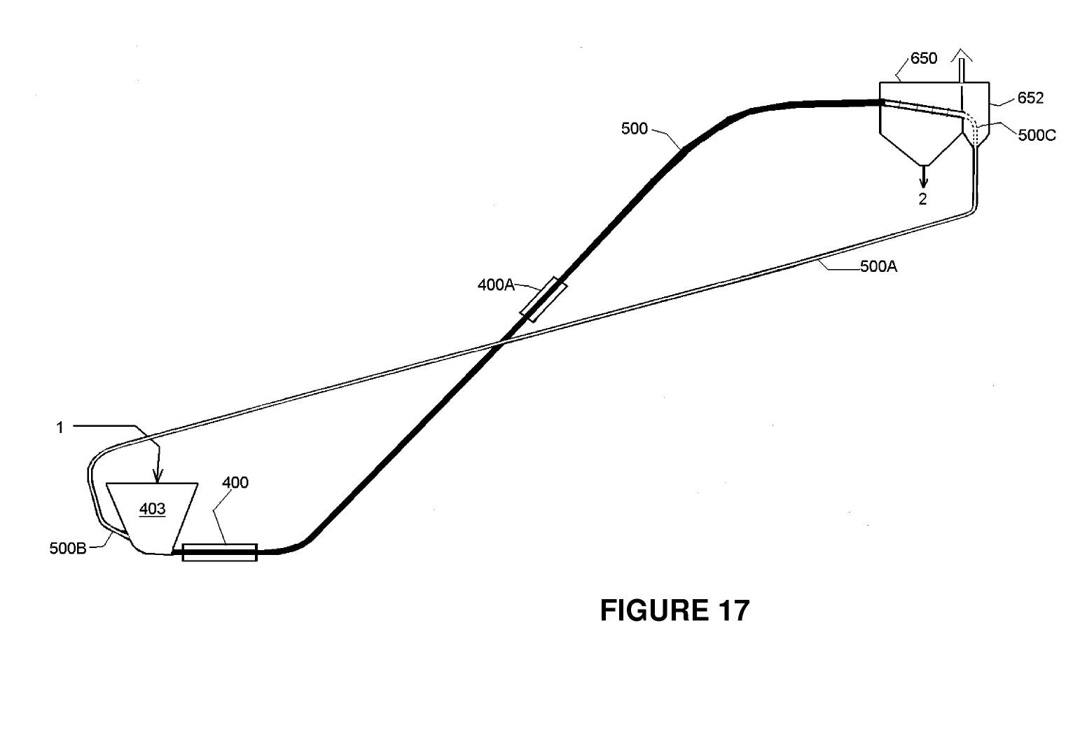

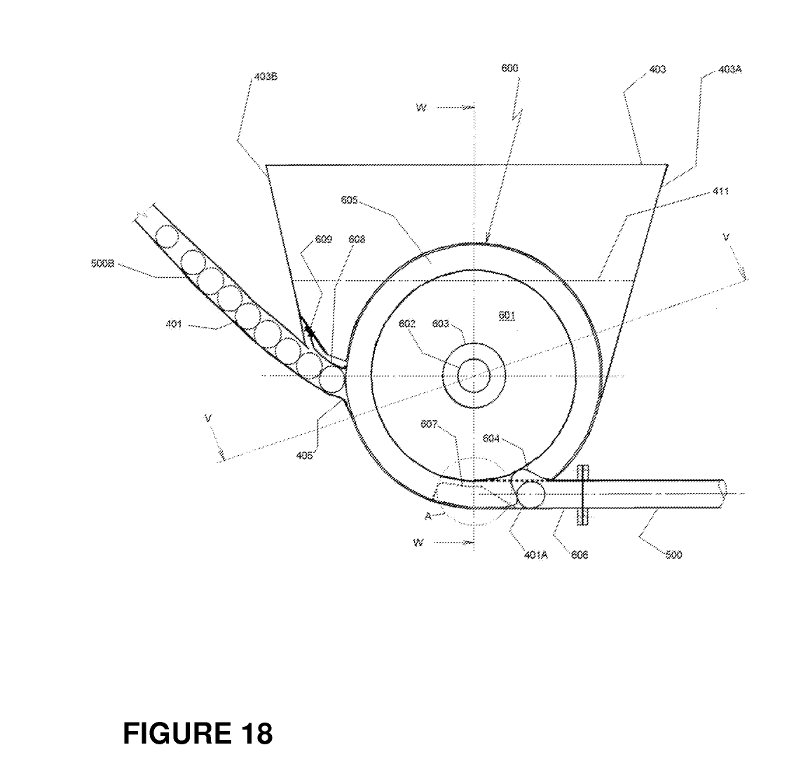

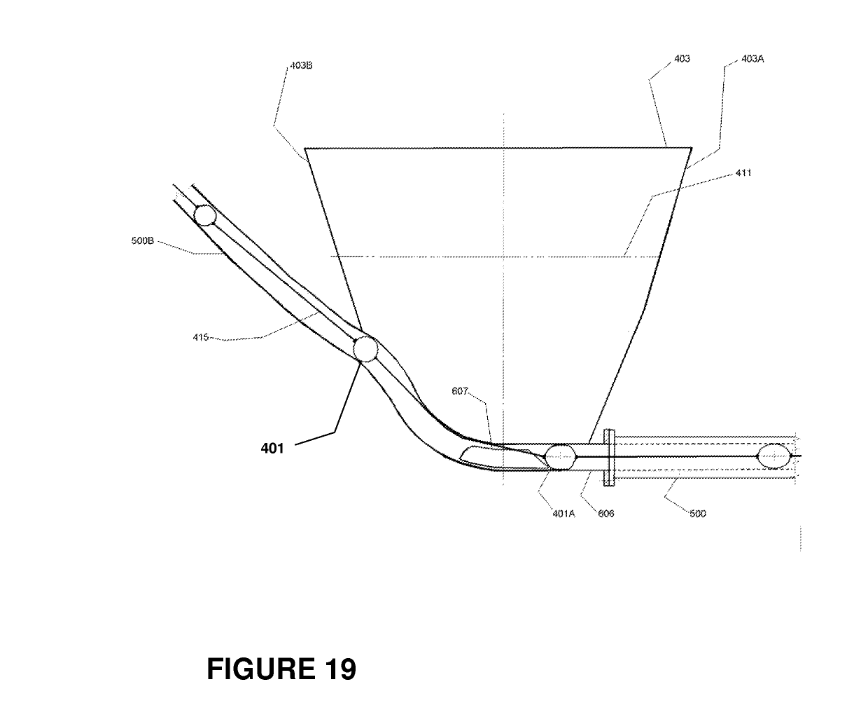

FIG. 17 is an alternative schematic to that shown in FIG. 14 wherein the pigs are recycled directly from the delivery station 650 to the feed station 403 through the recycle part of the pipeline loop 500A. In this arrangement the pipeline section within the pigs reservoir 652 is shown by dotted lines and the pigs reservoir 652 is unnecessary. The arrangement is suited to the gated pigs spacing mechanism 600 shown in FIG. 18, or the cable-linked pigs system of FIG. 19. No details of a valve system at 500B (needed for the gated pigs spacing system) are shown. Without a valve system, leakage of carrier fluid through pipeline loop 500A is only limited by the resistance of a column of pigs in the pipeline loop.

FIG. 18 is a schematic showing an example of an alternative feed station to that shown in FIG. 15 wherein the recycled pigs reservoir is omitted; pigs recycled from the delivery station accumulate in the pipeline part 500B, and the gating mechanism 600 controls the admission of pigs 401A into the pipeline entry 606. The pipeline part 500B is slightly larger than that of pipeline 500 to permit carrier fluid to leak past accumulating pigs. Leakage of carrier fluid through pipeline loop 500A is only limited by the resistance of a column of pigs in the pipeline loop.

FIG. 19 is a schematic showing an example of an alternative feed station to that shown in FIG. 18 wherein the pigs are linked by cables or ties 415 whose length determines the interval between each pair of pigs in the pipeline. Elsewhere in FIGS. 18 and 19 like numbers and letters indicate items that obtain the description provided for prior figures.

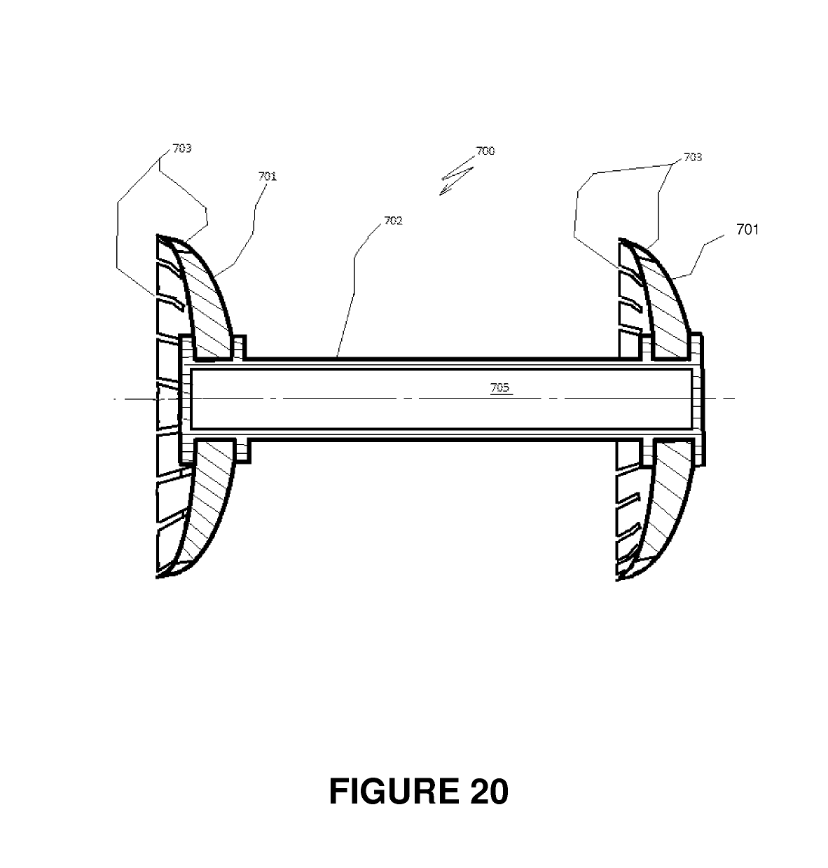

FIG. 20 shows a pig 700 comprising two saucer-shaped discs 701, with resilient rims that can pass easily through the check valve of FIG. 1, mounted securely on a stiff common central shaft 702; wherein the rims of the discs 701 have a number of slotted apertures 703, each of a slot area, disposed around the rims; whereby leakage of carrier fluid past each rim in a pipeline (into which the pig is inserted) is limited by the number of slots and the slot area, and wherein the centre 705 of central shaft is hollow to render the pig buoyant in the carrier fluid of the pipeline in which the pig is placed.

Although this invention has been described in connection with what is presently considered to be the most practical and preferred embodiments, it is to be understood that the invention is not to be limited to the disclosed aspects and examples: on the contrary, is intended to cover various modifications and equivalent arrangements included within the spirit and scope of the improvements to, or adaptations of, the prior invention, or present invention, and it can be embodied in other forms.

As an example, if the system of feeding and propelling pigs to provide long intervals between conveyed granules becomes impaired, or fails, granules travelling in rising or falling sections of the pipeline fall and segregate into denser accumulations. These denser accumulations can be difficult, even beyond the capacity of the carrier fluid propulsion means, to set in motion again when propulsion re-starts. A means of limiting the length of such denser accumulations into shorter, more easily set-in-motion-again accumulations, may be provided by the introduction of check valves of the kind exemplified by FIG. 1, positioned in the pipeline at appropriate places in inclined sections of the pipeline. Note that the pigs could be omitted from a short pipeline of this kind.

As another example, the flanged inlet and outlet ends of the flexible tubes shown in FIG. 4 may be omitted and, mutatis mutandis, replaced by the spigots of FIG. 1, and the screwed inlet and outlet ends of the check valve shown in FIG. 1 may be replaced by flanged connections.

As a further example, the materials of construction of the flexible tube need to be a flexible and fatigue resistant natural or synthetic rubber, and a knitted, or woven and bonded ligaments, or bonding-compatible, tensile stress resistant, abrasion and fatigue resistant fabric is required where an embedded or attached reinforcing fabric is needed. Elsewhere, metals or fibres-reinforced plastic may be used. In particular, the reinforcing members of FIG. 1 may be made from a fatigue and corrosion resistant steel.

1-16. (canceled)

17. A granules transport system, comprising:
a pipeline having an inlet and an outlet and a pump disposed between the inlet and the outlet;
a slurry disposed in the pipeline; the slurry comprising a carrier fluid and a plurality of granules dispersed in the carrier fluid;
a plurality of pigs segregating the slurry into a plurality of intervals, wherein the plurality of pigs comprise at least three pigs;
wherein the granules travel with the carrier fluid in the intervals from the inlet to the outlet;
wherein the pump is configured to pump the slurry and the pigs therethrough, with the pigs remaining present in the slurry, such that spacing between adjacent pigs is substantially maintained.

18. The granules transport system of claim 17:
wherein the pump comprises a flexible tube having a passage therethrough that is subject to expansion and contraction during pumping;
wherein the passage is sized and configured to allow passage of the pigs therethrough.

19. The granules transport system of claim 17 wherein the pump is further configured to maintain orientation of the pigs passing through the pump relative to the pipeline.

20. The granules transport system of claim 17:
wherein the pump is a first pump;
further comprising a second pump disposed between the first pump and the outlet;
wherein the second pump is configured to pump the slurry and the pigs therethrough, with the pigs remaining present in the slurry, such that spacing between adjacent pigs is substantially maintained.

21. The granules transport system of claim 17:
wherein the pump comprises a diaphragm pump comprising a pump inlet and a pump outlet;
wherein an inlet check valve is attached coaxially to the pump inlet;
wherein an outlet check valve is attached coaxially to the pump outlet;
wherein check valve comprises a respective flexible tube having an inlet portion and an outlet portion;
wherein each outlet portion is constrained against radially inward movement at three or more locations spaced around the periphery of the flexible tube.

22. The granules transport system of claim 21:
wherein a first of the check valves comprises a stiff ring surrounding the outlet portion of the corresponding flexible tube;
wherein the outlet portion of the first check valve is anchored to the stiff ring at the three or more locations.

23. The granules transport system of claim 21 wherein the outlet portion of the flexible tube of at least one of the check valves comprises folds to facilitate changes in cross-sectional shape of the corresponding outlet portion as the corresponding check valve opens and closes.

24. The granules transport system of claim 23 wherein the outlet portion of the flexible tube having folds is biased toward an unfolded configuration.

25. The granules transport system of claim 17:
further comprising a feed station disposed between the inlet and the pump;
wherein the feed station is operative to feed pigs into the pipeline upstream of the pump.

26. The granules transport system of claim 25 further comprising:
a delivery station disposed proximate the outlet; the delivery station operative to separate the pigs from the slurry;
a pig return line operatively connecting the delivery station to the feed station such that pigs from the delivery station are recycled to the feed station.

27. The granules transport system of claim 26:
wherein the pig return line contains carrier fluid to be recycled;
wherein the pig return line is sized to be bigger than the pigs such that at least some of the carrier fluid therein may move past the pigs therein.

28. The granules transport system of claim 17:
wherein the pump comprises a check valve having a flexible tube, the flexible tube having an upstream portion and a downstream portion;
wherein the upstream portion is configured to substantially close when pressure at an outlet of the pump is higher than a pressure at an inlet of the pump;
wherein the upstream portion is configured to open when the pressure at the inlet of the pump is higher than the pressure at the outlet of the pump;
wherein the downstream portion is restrained from closing when the pressure at the inlet of the pump is higher than the pressure at the outlet of the pump.

29. The granules transport system of claim 17:
wherein the pigs each comprise at least two spaced apart flexible rims mounted to a shaft;
wherein the flexible rims are resilient and comprise a plurality of peripheral apertures sized and configured to allow some of the carrier fluid to flow therethrough.

30. The granules transport system of claim 17 wherein the pigs are buoyant in the carrier fluid.

31. The granules transport system of claim 17:
wherein each pump in the pipeline comprises a first detector sensing the pressure upstream of each pump and a second detector sensing the pressure downstream of each pump;
whereby, when the pressure upstream falls to a first pre-determined level, the first detector triggers the pump to cease pumping;
whereby, when the pressure upstream rises to a second pre-determined level, the first detector triggers the pump to begin pumping;
whereby, when the pressure downstream falls to a third pre-determined level, the second detector triggers the pump to begin pumping;
whereby, when the pressure downstream rises to a fourth pre-determined level, the second detector triggers the pump to cease pumping;
wherein the first, second, third and fourth pre-determined levels differ for each pump.

32. The granules transport system of claim 17:
wherein the pump comprises at least three diaphragm pumps, each diaphragm pump comprising a pump inlet and a pump outlet serially and enclosedly linked;
wherein the pump is configured to open and close each of the diaphragm pumps in sequence to maintain a coordinated pumping action.
